(19) United States
(12) Patent Application Publication
(10) Pub. No.: US 2004/0179155 A1
(43) Pub. Date: Sep. 16, 2004

(54) LCOS imaging device

(76) Inventors: Samson Huang, Saratoga, CA (US); Thomas E. Willis, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/808,990

(22) Filed: Mar. 24, 2004

Related U.S. Application Data
(62) Division of application No. 10/334,959, filed on Dec. 30, 2002.

(51) Int. Cl. G02F 1/1335

(52) U.S. Cl. 349/113

(57) ABSTRACT

A single chip liquid crystal imaging device includes active circuitry under the connection area for the cover glass. For example, at least a portion of on-chip dual frame buffers is located under the epoxy bead which secures the cover glass to the silicon substrate.

### FIELD OF THE INVENTION

The present invention relates generally to liquid crystal devices, and more specifically to a liquid crystal on silicon imaging device.

### RELATED ART

Projection displays is one of the fastest growing areas in the display industry. Industry analysts report that about 2.4 million rear projection units were sold in 2001. This number is expected to grow significantly in the future. There are a number of key technologies competing for the rear projection display market share.

Cathode ray tube (CRT) based projectors while still being the mainstream technology facing an extremely difficult challenge to meet requirements of today's high performance systems. The systems are heavy and not portable and brightness is generally limited to fewer than 300 ANSI lumens.

A fast growing area of projection displays market is represented by poly-silicon based LCD projection systems. By producing better TFT transistors with higher temperature processes, this technology allows integration of the row and column drivers right into the quartz substrate, thus decreasing cost and increasing the aperture ratio. However, increasing yield for larger size panels remains a challenge for this approach.

Micro mirror devices are also used in a variety of rear projection systems. They operate by controlling the direction of reflected light on per pixel basis. These systems are known to achieve good contrast and brightness levels.

Recently, attention has been directed to building liquid crystal on silicon (LCOS) based projection displays. These displays essentially operate by electronically controlling a thin layer of liquid crystal (LC) material encapsulated between two substrates. For example, the two substrates include a transparent substrate (e.g. glass) and a reflective substrate (e.g. planarized and mirrored silicon substrate). There are several benefits to the use of reflective LCOS devices. The optical advantage is an increase of the effective aperture ratio because various control electronics can be hidden under the mirrored pixel structure. Electrically, the performance of the driver circuitry is very high because it is manufactured on a well known and proven CMOS process, which also leads to highly reliable and cost effective solutions.

There are two major approaches to liquid crystal (LC) control in LCOS devices, namely, analog and digital. Generally speaking, in analog devices the value of color is a function of the voltage applied to the pixel. For example, an analog scheme could be implemented by storing a voltage value in a capacitor underneath of the pixel surface. This voltage can then directly drive the LC material so that different voltage values produce different levels of intensity on the optical output.

While being successfully implemented in a variety of LCOS devices the analog scheme has a number of drawbacks. In order to achieve good color representation it requires a relatively large voltage range. In addition, it is very noise sensitive, especially when dealing with the darker portion of the color range.

Digital devices rely on a completely different approach. Instead of applying a range of voltages to the pixel, they effectively put the pixel in one of two states (e.g. “on” or “off”). In this case, it is not possible to directly drive the LC material with the digital information. Instead, there needs to be some conversion to an analog form that the LC material can Use. For example, pulse-width modulation (PWM) is one technique for generating color in an LCOS device. In this approach, the LC material is driven by a signal waveform whose “on” time is a function of the desired color value.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of a conventional LCOS device structure.

FIG. 2 is a fragmented cross sectional view taken along line 2-2 in FIG. 1.

FIG. 3 is a block diagram of an LCOS imaging device according to some embodiments of the invention.

FIG. 4 is a block diagram of an LCOS imaging device according to some embodiments of the invention.

FIG. 5 is a block diagram of a pixel cell of an LCOS imaging device according to some embodiments of the invention.

FIG. 6 is a perspective view of a display system according to some embodiments of the invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

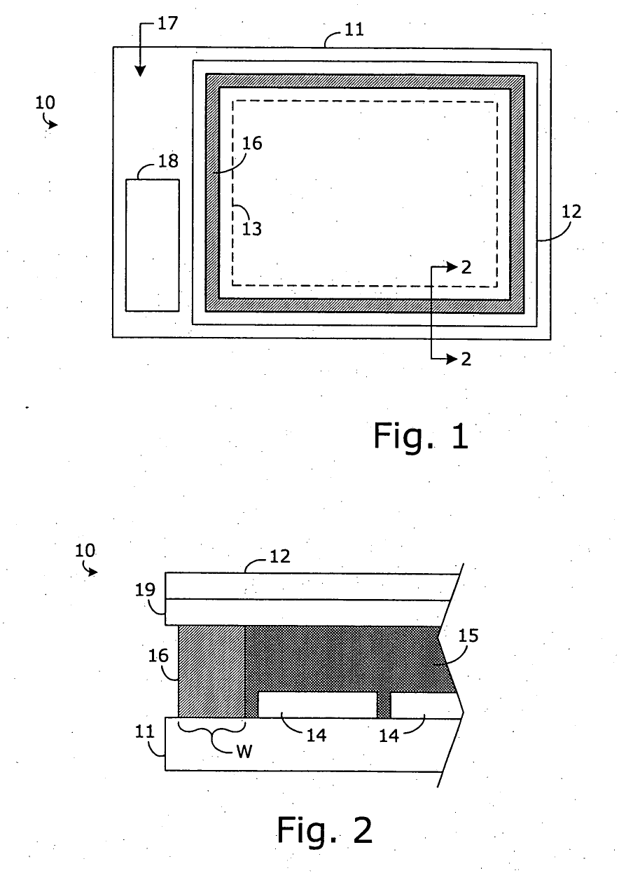

With reference to FIGS. 1-2, a display system includes an LCOS imaging device 10. Other components of the display system, such as a light engine and/or projection optics, are not shown. The device 10 includes a silicon substrate 11 and a cover glass 12 covering a pixel area-13 made up of pixel elements 14. Liquid crystal material 15 is disposed between the cover glass 12 and the substrate 11. The cover glass 12 is secured to the substrate 11 by an adhesive strip 16. The adhesive strip 16 defines an enclosed perimeter which seals the liquid crystal material 15 inside the area of the adhesive strip 16 under the cover glass 12. For example, the adhesive strip 16 is a bead of epoxy. The device 10 may include an area 17 on the substrate 11 outside of the area of the cover glass 12 (e.g. outside the area of the adhesive strip 16) which includes additional circuitry 18.

As can be seen in FIG. 2, the LC material 15 is sandwiched between the glass 12 and a reflective backplane made up of pixel elements 14. The distance between the cover glass 12 and the pixel elements 14 is known as the cell gap and typically ranges from 1 μm to 3 μm. For example, the pixel elements 14 are conductive electrodes which have been planarized or polished to a mirror surface. To provide a bias across the LC material 15, the cover glass 12 is coated with a thin layer of optically transparent, conductive material providing a common electrode 19 which covers the pixel area 13. For example, indium titanium oxide (ITO) is a suitable material for the common electrode 19. By changing the bias across the pixel element 14, the optical properties of the LC material 15 in a local region (i.e. pixel) can be changed. Modulating the potential between each pixel element 14 and the common electrode 19 changes the bias across the LC material 15. With proper modulation, a gray scale response can be achieved at each pixel in the device 10. The silicon backplane or an external source may provide the common electrode 19 bias signal. For example, the common electrode 19 may be grounded or set to a voltage of, for example, five volts (5V). The system may be DC balanced such that the voltage applied to the common electrode 19 changes every other display frame.

With reference to FIG. 2, in conventional LCOS imaging devices, a non-active area having a width W is allocated on the substrate 11 for packaging purposes (e.g. for the adhesive strip 16). For example, the area may be a narrow strip having a width of 0.75 to 1 mm wide for gluing the cover glass 12 to the substrate 11 (e.g. see hatched area of strip 16 in FIG. 1). However, because the adhesive must go around the perimeter of the cover glass 12 to seal the LC material 15, a significant area of silicon is not utilized.

The die size of the LCOS imaging device is an important parameter in determining the cost of the device. An advantage of some embodiments of the present invention is that the die size of an LCOS imaging device may be reduced, or alternatively, greater functionality may be provided for an LCOS imaging device without increasing die size. According to some embodiments of the invention, an LCOS imaging device utilizes the silicon in the area under the adhesive strip for active circuitry (e.g. in addition to interconnects), thereby reducing the die size of the LCOS imaging device.

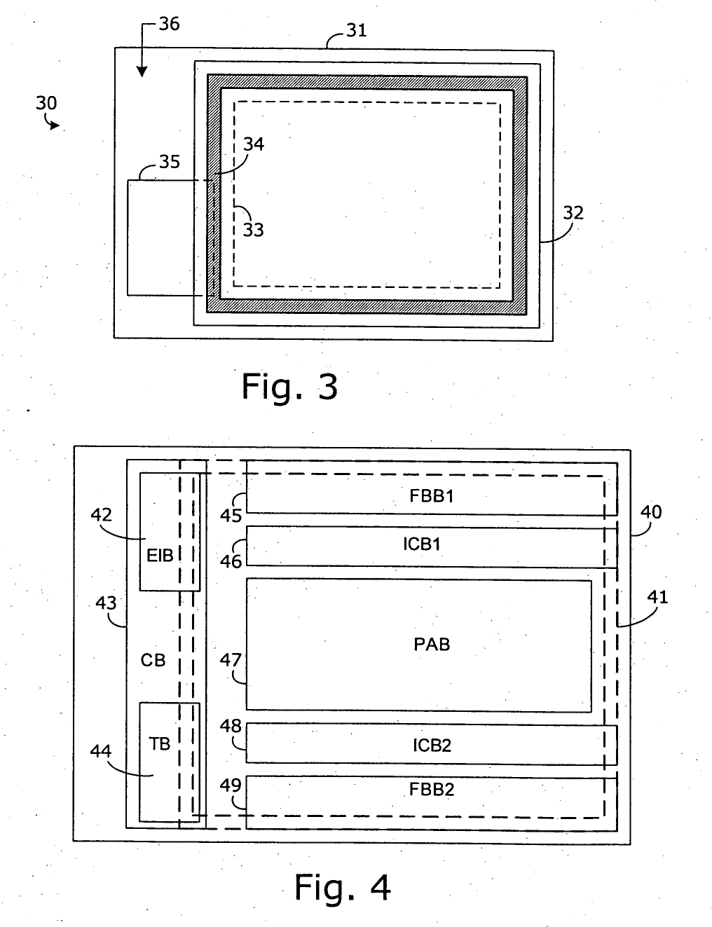

With reference to FIG. 3, an LCOS imaging device 30 includes a silicon substrate 31 and a cover glass 32 covering a pixel area 33 made up of pixel elements. Liquid crystal material is disposed between the cover glass 32 and the substrate 31. The cover glass 32 is secured to the substrate 31 by an adhesive strip 34. The adhesive strip 34 defines an enclosed perimeter which seals the liquid crystal material inside the area of the adhesive strip 34 under the cover glass 32. For example, the adhesive strip 34 is a bead of epoxy. Advantageously, the device 30 includes active circuitry 35 which is at least partially disposed under the area of the adhesive strip 34. The device 30 may include an area 36 on the substrate 31 outside of the area of the cover glass 32 (e.g. outside the area of the adhesive strip 34). The active circuitry 35 may extend into the area 36 and/or into the pixel area 33.

One approach to increasing the functionality of an LCOS imaging device involves utilizing the area underneath the active pixel for memory circuitry. However, a memory circuit utilizing a capacitor positioned underneath the active pixel requires more complex manufacturing processes. An advantage of some embodiments of the invention is that memory circuits may be provided on the die in the area under the adhesive strip, thus reducing the need for capacitive elements under the pixels.

In addition or as an alternative to a capacitor, a digital memory device is generally associated with the pixel area. For example, with digital modulation it is necessary to have access to the pixel data more than once per frame. In other words, the device needs to maintain a copy of the current frame data that can be referred to over the frame time. Moreover, double buffering is beneficial to support high frame rates, where the display device uses the “front” buffer to decide how to control the pixels, while the “back” buffer is accepting incoming pixel data for the next frame.

As noted above, some embodiments of the invention may provide greater functionality without significantly increasing a die size of an LCOS imaging device. Some embodiments of the invention provide a cost effective layout of the a single chip LCOS imaging device supporting on-chip dual frame buffers. For example, the single chip LCOS imaging device may provide an on-chip double-buffered PWM scheme.

With reference to FIG. 4, an LCOS imaging device according to some embodiments of the invention includes the following major blocks (not drawn to scale) on a single die 40. A pixel array block (PAB) 47 implements the pixel array and per-pixel storage elements. In general., the PAB 47 is spaced inward from the edge of the die 40 to allow room for an adhesive strip 41 (which secures the cover glass enclosing the liquid crystal material). An external interface block (EIB) 42 interfaces the device to the external world. A control block (CB) 43 generates the control signals necessary to perform refresh operations. A test block (TB) 44 provides design for test features. A first frame buffer block (FBB1) 45 which implements the pixel buffer that holds the pixel values for the current frame of video data (e.g. the front buffer). A first interface control block (ICB1) 46 provides the interface between the frame buffer and pixel array PAB 47 and helps compute the PWM waveform values. A second frame buffer block (FBB2) 49 for receiving the next frame of video data (e.g. the back buffer) with an associated second interface control block (ICB2) 48 providing the interface between the FBB2 49 and the PAB 47.

For example, the EIB 42 is adapted to receive pixel data from the external world and place it into the frame buffers FBB1 45 and FBB2 49. The EIB 42 may be further adapted to load configuration data into the part and to provide some control information to the outside world.

As illustrated in FIG. 4, some embodiments of the invention include portions of the first and second frame buffers (FBB1 45 and FBB2 49), the associated first and second interface blocks (ICB1 46 and ICB2 48) and the control block (CB 43) located on the periphery of the die 40 and at least partially located within the area under an adhesive strip 41 that attaches the cover glass to the die 40, thus saving valuable die size. If the size and complexity of the device permits, it is preferable that the frame buffers are located completely within the area under the adhesive strip 41, thus providing increased functionality with no increase in die size. In most applications, the pixel array has a rectangular shape with one set of edges being longer than the other set of edges (i.e. not a square, an aspect ratio other than 1:1). Since in most configurations the control block (e.g. CB 43) is a small block, it may be preferred to locate the frame buffers (e.g. FBB1 45 and FBB2 49) along the longer edge of the pixel array because the frame buffers are likely to be large. As shown in FIG. 4, some embodiments of the invention provide a floor plan which allows the data to flow vertically from the frame buffers to the interface control block and then to the pixel array block. Preferably, the circuitry for each column in the blocks is aligned. In some embodiments, it may be preferred to locate the EIB 42 along the narrow dimension of the pixel array to allow the external interface to be provided from the narrow side of the die 40.

With reference to FIG. 4, an alternative functional implementation according to some embodiments of the invention is to divide the blocks in the core pixel path (e.g. the FBB, ICB, and PAB) into two independent banks. In this arrangement, each bank is adapted to manage one half of the rows in the display. An advantage of banking is that the configuration provides parallelism to the die 40 and allows lower operating speeds than might otherwise be possible. For example, the first frame buffer block FBB1 45 could implement a first bank and the second frame buffer block FBB2 49 could implement a second bank, with corresponding changes in the configuration of the EIB 42, the CB 43, and the associated ICBs (ICB1 46 and ICB2 48) to implement the banking scheme. In some examples, the first bank corresponds to one half of the rows in the pixel array (e.g. the upper half) and the second bank corresponds to the other half of the rows in the pixel array (e.g. the lower half).

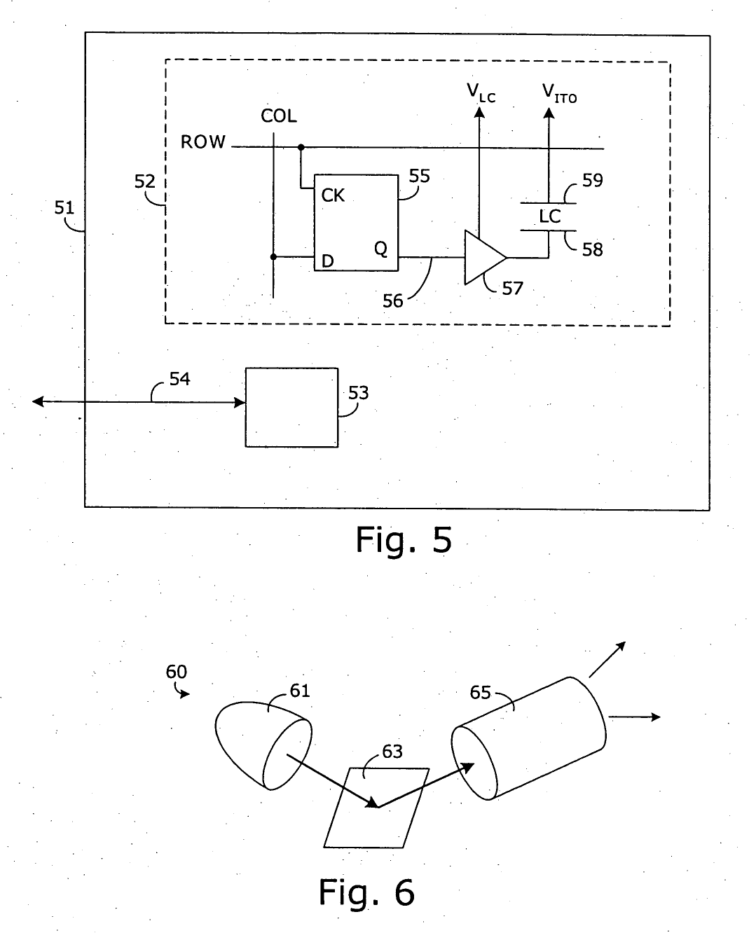

Additionally, in some embodiments, to conserve space a part of each frame buffer bank is co-located with the pixel in the pixel array. With reference to FIG. 5, some embodiments of the invention include a co-located pixel drive circuit and memory cell placed beneath the reflective surface of a pixel. With reference to FIG. 5, a pixel element 51 has an associated driver circuit 52 and a digital memory circuit 53 co-located with the pixel element 51. For example, the memory circuit 53 includes an eight bit SRAM cell which is part of the frame buffer. The memory circuit 53 does not necessarily directly connected to the drive circuit 52 and may send and receive data over a signal 54. The drive circuit 52 receives a ROW signal and a COL signal, corresponding to respective row and column information. The ROW signal is provided to a clock input CK of a D-flip/flop 55 and the COL signal is provided to an input D of the D-flip/flop 55. The D-flip/flop holds the current state of the PWM waveform for the pixel. The PWM waveform is applied to a signal line 56, corresponding to an output Q of the D-flip/flop 55. The PWM waveform is provided to an input of a buffer circuit 57. Liquid crystal material (LC) is disposed between a pixel electrode 58 and a common electrode 59. The buffer circuit 57 is configured to translate from logic level voltages to V_{LC}, a voltage level compatible with the LC material. The specific value of V_{LC} depends on the LC material. An output of the voltage translation buffer 57 drives the pixel electrode 58 of the pixel element 51. The ITO bias voltage, V_{ITO} is applied to a common electrode 59 to provide the proper bias to the LC cell and to preserve DC balance.

With reference to FIG. 6, a display system 60 according to some embodiments of the invention includes a light engine 61, an LCOS imaging device 63 receiving light from the light and encoding the light with image information, and a projection lens 65 receiving the encoded light from the LCOS imaging device 63 and projecting the encoded light. In some embodiments, the LCOS imaging device 63 include a die having active circuitry disposed under an adhesive strip (e.g. an epoxy bead securing a cover glass to the die). In some embodiments, the LCOS imaging device 63 comprises a single chip LCOS imaging device supporting on-chip dual frame buffers. For example, the single chip LCOS imaging device may provide an on-chip double-buffered PWM scheme. In some embodiments, the LCOS imaging device 63 includes features as described above in connection with FIGS. 3-5.

The foregoing and other aspects of the invention are achieved individually and in combination. The invention should not be construed as requiring two or more of the such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An integrated circuit, comprising:
a silicon substrate;
a light modulation structure formed on a first area of the substrate; and
a cover glass covering the light modulation structure and secured to the substrate on a second area of the substrate, wherein at least a portion of an active circuit is formed on the second area of the substrate.

2. The integrated circuit as recited in claim 1, wherein the light modulation structure comprises a pixel array.

3. The integrated circuit as recited in claim 1 wherein the cover glass is secured to the substrate by an adhesive on the second area, and the portion of the active circuit is located under the adhesive.

4. The integrated circuit as recited in claim 3, wherein a significant portion of the active circuit is located under the adhesive.

5. The integrated circuit as recited in claim 3, wherein substantially all of the active circuit is located under the adhesive.

6. The integrated circuit as recited in claim 3, wherein the adhesive comprises an adhesive strip defines an enclosed perimeter.

7. The integrated circuit as recited in claim 6, wherein the adhesive strip comprises an epoxy bead.

8. The integrated circuit as recited in claim 1, wherein the active circuit comprises a memory circuit.

9. The integrated circuit as recited in claim 8, wherein the memory circuit comprises a first frame buffer and a second frame buffer.

10. A single chip liquid crystal on silicon imaging device, comprising:
an on-chip light modulator on the chip; and
on-chip dual frame buffers on the chip.

11. The device as recited in claim 10, wherein the light modulator comprises a pixel array.

12. The device as recited in claim 10, further comprising a cover glass covering the light modulator and secured to the chip by an adhesive, wherein at least a portion of the on-chip dual frame buffers is formed on the chip under the adhesive.

13. The device as recited in claim 12, wherein a significant portion of the on-chip dual frame buffers is located under the adhesive.

14. The device as recited in claim 12, wherein substantially all of the on-chip dual frame buffers is located under the adhesive.

15. A liquid crystal on silicon imaging device, comprising:
a cover glass;
a silicon backplane physically connected to the cover glass in a connection area; and
a liquid crystal sealed between said cover glass and said silicon backplane;
wherein said silicon backplane comprises:
a frame buffer configured to store pixel data;
a pixel array;
an interface control block connected between the frame buffer and the pixel array, the interface control block being adapted to determine pulse width modulation waveforms for the pixel array in accordance with the pixel data stored in the frame buffer; and
an external interface block configured to provide an external interface to the device, including receiving pixel data and transferring the received pixel data into the frame buffer; and
a control block connected to the external interface block, the frame buffer, and the interface control block, the control circuit being adapted to provide control signals to operate the device.

16. The liquid crystal on silicon imaging device as recited in claim 15, wherein at least a portion of the frame buffer block includes memory cells co-located with pixel-elements of the pixel array.

17. The liquid crystal on silicon imaging device as recited in claim 15, wherein the frame buffer includes a front buffer and a back buffer.

18. The liquid crystal on silicon imaging device as recited in claim 15, wherein the frame buffer, the interface control block and the control block are located on a periphery of the device and at least partially fit within the connection area where the cover glass is attached to the backplane.

19. The liquid crystal on silicon imaging device as recited in claim 18, wherein the frame buffer, the interface control block, and the pixel array are divided into first and second parts, wherein the first part is associated with a first half of rows of the pixel array and the second part is associated with a second half of rows of the pixel array.

20. A display system, comprising:
a light engine;
a projection lens; and
a single chip liquid crystal on silicon imaging device configured to receive light from the light-engine, encode the light from the light engine with image information, and provide the encoded light to the projection lens, wherein the single chip imaging device includes on-chip dual frame buffers.

21. The system as-recited in claim 20, wherein the imaging device comprises a pixel array.

22. The system as recited in claim 21, further comprising a cover glass covering the pixel array and secured to the single chip imaging device by an adhesive, wherein at least a portion of the on-chip dual frame buffers is formed on the chip under the adhesive.

23. The system as recited in claim 22, wherein a significant portion of the on-chip dual frame buffers is located under the adhesive.

24. The system as recited in claim 22, wherein substantially all of the on-chip dual frame buffers is located under the adhesive.
